(19) United States
(12) Patent Application Publication
(10) Pub. No.: US 2010/0079775 A1
(43) Pub. Date: Apr. 1, 2010

(54) IMAGE FORMING APPARATUS

(75) Inventor: Kenji MATOBA, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/553,865

(22) Filed: Sep. 3, 2009

(30) Foreign Application Priority Data
Sep. 26, 2008 (JP) 2008-248232

(51) Int. Cl. H04N 1/60

(52) U.S. Cl. 358/1.9

(57) ABSTRACT

An image forming apparatus includes an image forming portion which includes a nozzle surface having at least one nozzle and which is configured to form an image on a recording medium by ejecting ink toward the recording medium through the at least one nozzle, a feeding portion which includes a feeding surface on which the recording medium is placed and which is configured to feed the recording medium toward the image forming portion in a feeding direction, and a detecting portion which is configured to detect a state of lift of the recording medium relative to the feeding surface. The detecting portion includes a contact portion which is contactable with at least a part of a portion of the recording medium that is in the state of lift and a sensing portion which senses that the recording medium and the contact portion contact with each other.

### CROSS REFERENCE TO RELATED APPLICATION

The present application claims priority from Japanese Patent Application No. 2008-248232, which was filed on Sep. 26, 2008, the disclosure of which is herein incorporated by reference in its entirety.

### BACKGROUND OF THE INVENTION

1. Field of the Invention

The present invention relates to an image forming apparatus.

2. Discussion of Related Art

There is known a so-called inkjet printer which forms an image on a recording medium by ejecting ink from an inkjet head to the recording medium that is fed by a feed belt. In the inkjet printer, a distance between the inkjet head and the feed belt is set to be small in order that the ink from the inkjet head can be landed on the recording medium with high accuracy.

Therefore, in a case where the recording medium reaches an area opposite to the inkjet head in a state in which the recording medium is lifted, the recording medium is likely to contact the inkjet head, so that a jam or jamming occurs and/or the recording medium is stained with ink because the ink stuck to or adhered to the inkjet head is spread to the recording medium. Thus, in the above-mentioned inkjet printer, it is desired to detect whether a lift of the recording medium occurs or not before the recording medium reaches the area opposite to the inkjet head.

On the other hand, U.S. Pat. No. 5,582,399, corresponding to JP 7-291480 A (hereinafter, referred to as “Patent Document 1”), discloses that, concerning a detector of a recording medium, there is provided a pivot member which pivots to appear on or disappear from a feed path of the recording medium in a pendulum-like way so as to disappear from the feed path during a period of time from when a leading edge of the recording medium being fed contacts the pivot member to when a trailing edge of the recording medium passes through the pivot member, and so as to appear on the feed path after the trailing edge of the recording medium passes through the pivot member, and discloses that whether the leading edge or the trailing edge of the fed recording medium passes through the pivot member is detected by detecting a pivot movement of the pivot member by a photosensor.

However, in the above-described technique disclosed in Patent Document 1, it is impossible to precisely detect whether a lift of the recording medium occurs or not. For example, in a case where a portion of the recording medium that is located apart from a position where the pivot member is provided (e.g., a corner of the leading edge of the recording medium) is lifted, the pivot member is normally operated and cannot detect an occurrence that the above-mentioned portion of the recording medium is lifted.

### SUMMARY OF THE INVENTION

It is therefore an object of the present invention to solve the above-mentioned problem and to provide an image forming apparatus that precisely detects an occurrence of a lift of the recording medium before an image is formed on the recording medium.

According to the present invention, there is provided an image forming apparatus comprising: an image forming portion which includes a nozzle surface having at least one nozzle and which is configured to form an image on a recording medium by ejecting ink toward the recording medium through the at least one nozzle; a feeding portion which includes a feeding surface on which the recording medium is placed and which is configured to feed the recording medium toward the image forming portion in a feeding direction; and a detecting portion which is configured to detect a state of lift of the recording medium relative to the feeding surface. The detecting portion includes a contact portion which is contactable with at least a part of a portion of the recording medium that is in the state of lift and a sensing portion which senses that the recording medium and the contact portion contact with each other.

In the present image forming apparatus, since the contact portion which is contactable with at least the part of the portion of the recording medium that is in the state of lift, in a case where the recording medium that is fed to the image forming portion is lifted, at least the part of the portion of the recording medium that is in the state of lift contacts the contact portion and the sensing portion senses that the recording medium and the contact portion contact with each other. Thus, it can be detected that the lift of the recording medium occurs.

### BRIEF DESCRIPTION OF THE DRAWINGS

The above and optional objects, features, and advantages of the present invention will be better understood by reading the following detailed description of the preferred embodiments of the invention when considered in conjunction with the accompanying drawings, in which:

FIG. 1 is a perspective view schematically showing a printer as one embodiment to which the present invention is applied;

FIG. 2 is a vertical cross-sectional view showing a structure of the printer;

FIG. 3A is a front view of a pendular member of the printer, and FIG. 3B is a plan view around the pendular member;

FIG. 4A is a schematic view showing a state in which a recording medium is fed without being lifted from a feed belt, and FIG. 4B is a schematic view showing a state in which the recording medium that is in a state of lift from the feed belt contacts the pendular member;

FIG. 5 is a block diagram showing an electric structure of the printer;

FIG. 6 is a flow chart illustrating a printing operation of the printer; and

FIG. 7A and FIG. 7B are front views respectively showing structures of pendular members as another embodiments to which the present invention is applied.

### DETAILED DESCRIPTION OF THE PREFERRED EMBODIMENTS

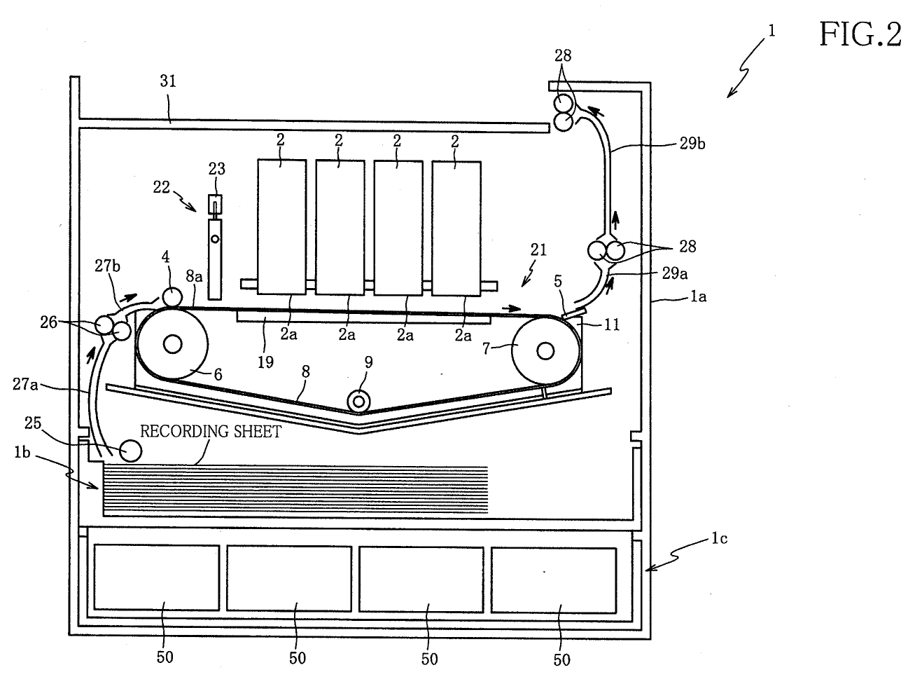

Hereinafter, there will be described preferred embodiments of the present invention with reference to the drawings. In the present embodiment, a printer 1 as one embodiment of an image forming apparatus is a line-type inkjet printer, and is arranged to prevent a recording sheet P as a recording medium that is in a state of lift from being fed to printing heads 2 (shown in FIG. 2). The printer 1 is an example of a Multifunction Peripheral (MFP).

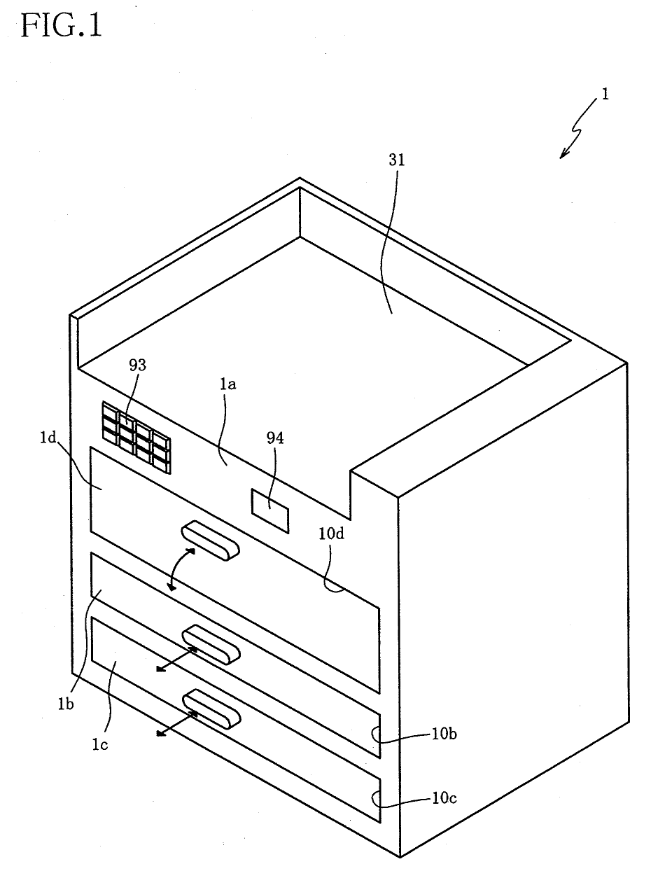

As shown in FIG. 1, the printer 1 includes a casing 1a having a generally rectangular parallelepiped shape, and in a front surface (or a front-side surface in FIG. 1) of the casing 1, there are respectively fitted in the following order from upside, a plurality of operation keys 93 for being operated by a user or an operator, a state indication lamp 94 which indicates various states of the printer 1 with lighting indication, an opening 10d, a door 1d which is fit into the opening 10d and is openable and closable about a support (or a fulcrum) point that is a horizontal axis extending in a lower end of the door 1d, an opening 10b into which a sheet-supply unit 1b that accommodates a plurality of recording sheets P in a stacked manner is insertable, and an opening 10c into which an ink tank unit 1c for reserving (or accommodating) ink is insertable. On an upper portion of the casing 1a, there is disposed a sheet-discharge portion 31 to which a printed recording sheet P is discharged.

The operation keys 93 are keys for setting various functions of the printer 1 and instructing the printer 1 to perform various operations. For example, through the operation keys 93, a kind or a sort of the recording sheet P such as a regular paper or a postcard, a resolution of the recording sheet P such as a draft mode or a photo mode can be set, and a start of printing or a suspend (or a stop) of printing can be instructed. In the state indication lamp 94, for example, a red light turns on to indicate a case where an error (a failure) occurs such as jamming in the printer 1, and a green light turns on to indicate a case where the printing (operation) is normally finished.

Hereinafter, an internal structure of the printer 1 will be described with reference to FIG. 2. FIG. 2 shows respective states in which the sheet-supply unit 1b is inserted into the opening 10b and in which the ink tank unit 1c is inserted into the opening 10c.

In an upper portion inside the casing 1a of the printer 1, there are disposed a plurality (in the present embodiment, four) of the printing heads 2 that are provided corresponding to respective colors of inks including C (cyan), M (magenta), Y (yellow) and K (black) inks, and a feeding unit 21 that feeds the recording sheets P to the printing heads 2. Each recording sheet P stacked in the sheet-supply unit 1b is fed inside the printer 1 in a direction indicated by arrows in FIG. 2 or in a feeding direction and discharged to the sheet-discharge portion 31 after a desired image is printed thereon.

The sheet-supply unit 1b includes a sheet-supply roller 25 for supplying or feeding each of the stacked recording sheets P to guides (or guide members) 27a, 27b. The sheet-supply roller 25 is operable to supply an uppermost one of the recording sheets P stacked in the sheet-supply unit 1b to the guides 27a, 27b. Guided by the guides 27a, 27b, the recording sheet P supplied from the sheet-supply unit 1b is nipped by a pair of feed rollers 26 and is fed to the feeding unit 21.

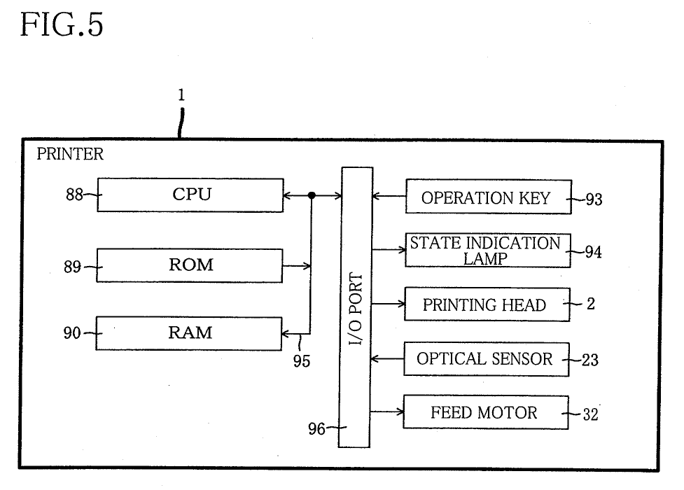

The feeding unit 21 includes a pair of belt rollers 6, 7, an endless feed belt 8 that is wound on the pair of belt rollers 6, 7, a tension roller 9 and a pair of support frames 11 that support the belt rollers 6,7 and the tension roller 9 to be rotatable. The tension roller 9 biases the feed belt 8 downward by contacting an inner circumferential surface of the feed belt 8 so as to apply a tension to the feed belt 8. The belt roller 7 is a drive roller that is driven by a feed motor 32 (shown in FIG. 5) and is rotated in a clockwise direction in FIG. 2. The belt roller 6 is a driven roller that is rotated with a circulation of the feed belt 8 by a rotation of the belt roller 7 and is rotated in the clockwise direction in FIG. 2.

At a position opposite to the belt roller 6 with respect to the feed belt 8, there is disposed a nip roller 4. The nip roller 4 is operable to press the recording sheet P supplied from the sheet-supply unit 1b on the outer circumferential surface 8a of the feed belt 8 as a feeding surface so that a whole of the recording sheet P is supported by the outer circumferential surface 8a. The recording sheet P that is placed on the feed belt 8, except in a case that the recording sheet P is lifted from the outer circumferential surface 8a of the feed belt 8, is passed through a space between the outer circumferential surface 8a of the feed belt 8 and a pendular (or a pendulum) member 22 and is fed to the printing heads 2 in the feeding direction.

The pendular member 22 as a contact portion is located on an upstream side of the printing heads 2 in the feeding direction of the recording sheet P and is operable to contact the recording sheet P in a state of lift from the outer circumferential surface 8a of the feed belt 8. When the recording sheet P contacts the pendular member 22, the pendular member 22 pivots or swings to a downstream side in the feeding direction of the recording sheet P, and a pivot or a swing of the pendular member 22 is detected by an optical sensor 23 as a sensing portion, and, based on an output signal from the optical sensor 23, a CPU 88 (shown in FIG. 5) determines that the recording sheet P is in the state of lift.

Each of the four printing heads 2 corresponds to the respective four colors of inks (M, C, Y and K), and extends in a main scanning direction or in a widthwise direction of the feed belt 8 that is perpendicular to a longitudinal (or a lengthwise) direction of the feed belt 8. The four printing heads 2 are arranged in a sub-scanning direction that is perpendicular to the main scanning direction or in the feeding direction. Each printing head 2 is connected to the ink tank unit 1c via a corresponding one of four ink tubes (not shown). The ink tank unit 1c includes four ink tanks 50 for individually accommodating the four colors of inks, and corresponding colors of inks are supplied from the respective ink tanks 50 to the respective printing heads 2.

Further, on a lower surface of each printing head 2, there is formed an ink ejection surface 2a as a nozzle surface, and the ink ejection surface 2a has a plurality of ink ejection openings as nozzles, not shown, that are arranged in the main scanning direction. It is arranged that inks can be simultaneously (or concurrently) ejected through the respective ink ejection openings, so that, by one concurrent ink ejection from the respective ink ejection openings, each line of an image in the main scanning direction can be formed at once on the recording sheet P.

In a loop-shaped space of the feed belt 8 that is an inner space defined by the feed belt 8, a platen 19 having a generally rectangular parallelepiped shape is disposed. The platen 19 is fixed to the pair of support frame 11 at opposite ends thereof in the main scanning direction. An upper surface of the platen 19 is held in contact with the inner circumferential surface of the feed belt 8 and supports the feed belt 8 from inside of the feed belt 8. Accordingly, the respective ink ejection surfaces 2a of the four printing heads 2 and the outer circumferential surface 8a of the feed belt 8 that is opposed to the respective ink ejection surfaces 2a can be in parallel with each other and are opposed to each other, and also a small distance between the respective ink ejection surfaces 2a and the outer circumferential surface 8a of the feed belt 8 can be made (spaced) with high accuracy. The above-mentioned distance is made in order for the recording sheet P that is supported by the feed belt 8 to pass below the printing heads 2 without contacting the ink ejection surfaces 2a of the printing heads 2.

The recording sheet P that is supported by the feed belt 8 passes below the four printing heads 2 in order in the feeding direction, so that an image is formed on the recording sheet P. When the recording sheet P passes below the respective four printing heads 2, inks are ejected from the respective ink ejection surface 2a of the respective printing heads 2, and an ink ejection from each ejection surface 2a at one time forms one line of image on the recording sheet P. Feeding of the recording sheet P by the feed belt 8 and forming of the one line of image on the recording sheet P are repeatedly performed, so that the image is formed on the whole of the recording sheet P. The recording sheet P on which the image is formed is further fed to a downstream side in the feeding direction by the feeding unit 21.

On the downstream side of the printing heads 2 in the feeding direction and at a position that is opposite to the belt roller 7 with respect to the feed belt 8, a separate plate 5 is disposed. The separate plate 5 is operable to separate the recording sheet P that is supported by the outer circumferential surface 8a of the feed belt 8 from the outer circumferential surface 8a. The recording sheet P that is separated from the outer circumferential surface 8a by the separate plate 5 is, guided by guides (guide members) 29a, 29b, nipped by a pair of feed rollers 28 and discharged to the sheet-discharge portion 31.

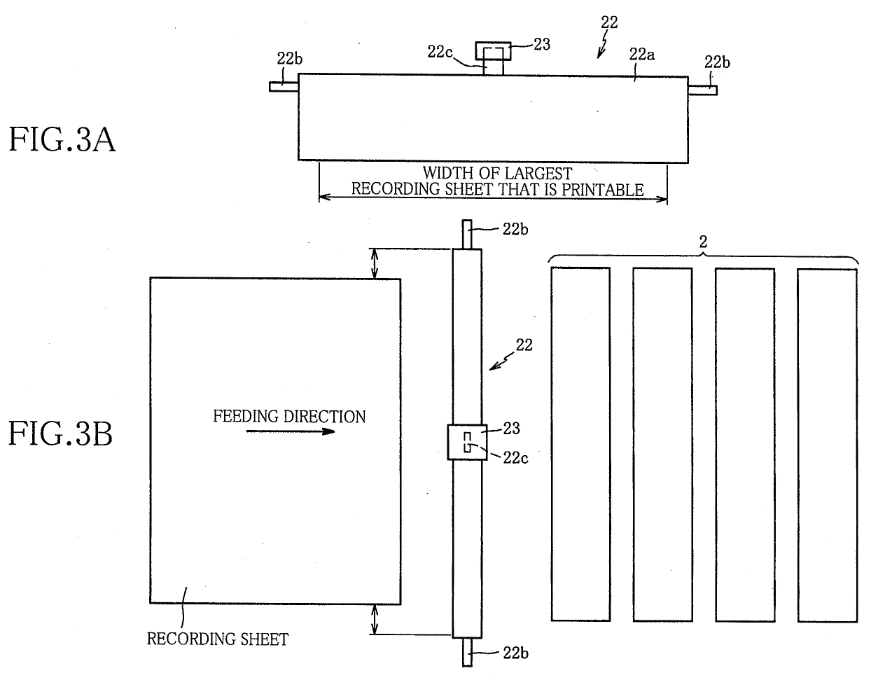

Hereinafter, a structure of the pendular member 22 will be described with reference to FIGS. 3A and 3B. As shown in FIG. 3A, the pendular member 22 includes (1) a contact plate 22a that has a plate-like structure and extends in a direction that is perpendicular to the feeding direction of the recording sheet P or in the main scanning direction, (2) a pair of shaft portions 22b that support the contact plate 22a so as to be pivotable in the feeding direction of the recording sheet P and in a direction opposite to the feeding direction, and (3) a projection 22c that projects upward from a center or a middle of an upper end of the contact plate 22a in a lengthwise direction thereof. In the present embodiment, because the contact plate 22a has a plate structure whose thickness direction extends in the feeding direction, a dimension of the contact plate 22a in the feeding direction can be minimized, so that it is easy that the contact plate 22a is located on the upstream side of the printing head 2 in the feeding direction.

The contact plate 22a is contactable with the recording sheet P in the state of lift. A dimension of the contact plate 22a measured in the lengthwise direction or a width of the contact plate 22a in the main scanning direction is made larger than a width of the recording sheet P that is the largest among recording sheets on which the printer 1 can print an image. Therefore, in a case where a whole of a leading edge of the recording sheet P in the feeding direction is lifted from the feed belt 8, or in a case where a part of the leading edge of the recording sheet P in the feeding direction is lifted from the feed belt 8, the whole or the part of the leading edge of the recording sheet P can contact the contact plate 22a. Not only in the case where the leading edge of the recording sheet P is lifted, but in a case where a middle of the recording sheet P in the feeding direction or a trailing edge thereof is lifted, the middle or the trailing edge of the recording sheet P can contact the contact plate 22a. The state in which the recording sheet P is lifted from the outer circumferential surface 8a of the feed belt 8 means a state in which the recording sheet P is lifted relative to the outer circumferential surface 8a at a height (or a dimension in the vertical direction) that is larger than the distance between the contact plate 22a and the outer circumferential surface 8a. In a case where at least a part of the recording sheet P is lifted at the above-mentioned height, it means that the recording sheet P is in the state of lift from the outer circumferential surface 8a of the feed belt 8.

When the recording sheet P contacts the contact plate 22a, the pendular member 22 pivots in the feeding direction and a displacement of the pendular member 22 is detected by the optical sensor 23 (described later), so that it is determined by the CPU 88 (shown in FIG. 5) that the lift of the recording sheet P occurs.

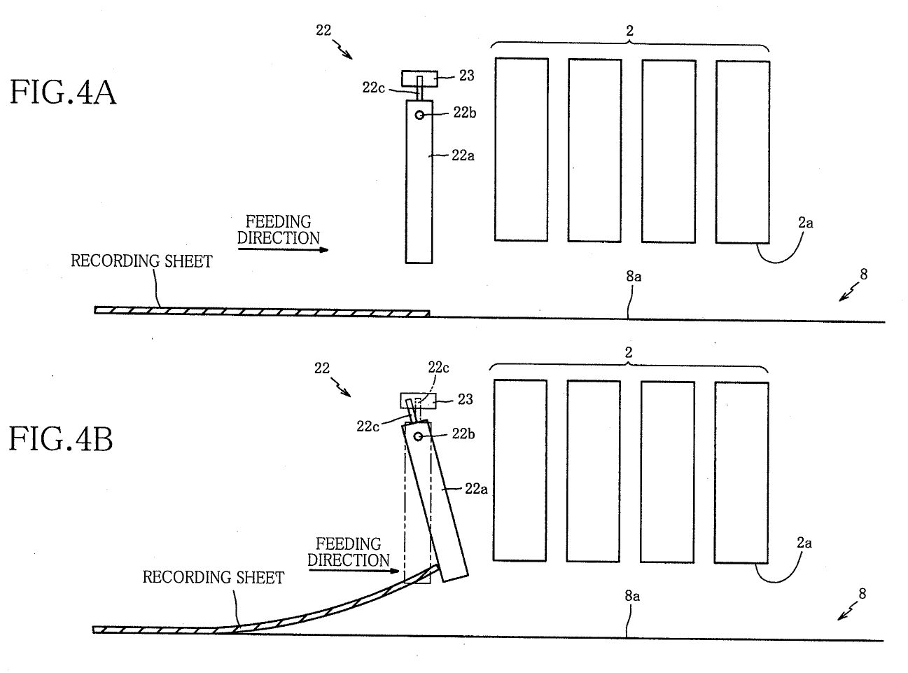

Though more details will be described later with reference to FIGS. 4A and 4B, a lower end of the contact plate 22a is located at a (height) position (in the vertical direction) that is closer to the outer circumferential surface 8a of the feed belt 8 than the respective ink ejection surfaces 2a of the printing heads 2. This is because, in a case where the recording sheet P is fed on the feed belt 8, the recording sheet P that is possible to contact the ink ejection surface 2a when being continuously fed can surely contact the contact plate 22a and an occurrence of the lift of the recording sheet P can be surely detected before the recording sheet P reaches the ink ejection surface 2a.

The pair of shaft portions 22b are respectively projected from the contact plate 22a on the same axis extending in the main scanning direction and respective ends of the shaft portions 22b are (rotatably) supported in an inner portion of the casing 1a. These shaft portions 22b function as a spindle or a support axis so that the contact plate 22a pivots in the feeding direction of the recording sheet P and in the opposite direction to the feeding direction.

The projection 22c consists of a lightproof or a shading member that intercepts light, and the optical sensor 23 is disposed such that the projection 22c is located inside thereof. The optical sensor 23 has a light-emitting portion (not shown) that emits light and a light-receiving portion (not shown) that receives the light emitted from the light-emitting portion. The projection 22c is located between the light-emitting portion and the light-receiving portion of the optical sensor 23, and the light-emitting portion and the light-receiving portion are fixed to the inner portion of the casing 1a such that respective positions of the light-emitting portion and the light-receiving portion are not changed when the contact plate 22a of the pendular member 22 pivots.

In a case where the contact plate 22a of the pendular member 22 stands still or is positioned at a resting (or a static) position, the light emitted from the light-emitting portion of the optical sensor 23 is intercepted or shielded by the projection 22c, so that the light is not received by the light-receiving portion. In this case, the optical sensor 23 outputs no signals to the CPU 88 (shown in FIG. 5), i.e., an output signal from the optical sensor 23 is OFF. As a result, in the CPU 88, it is determined that the lift of the recording sheet P does not occur.

On the other hand, in a case where the contact plate 22a pivots, the position of the projection 22c is changed, so that the light that has been intercepted by the projection 22c passes and is received by the light-receiving portion. In this case, the optical sensor outputs ON signal to the CPU 88, i.e., the output signal from the optical sensor 23 is ON. As a result, in the CPU 88, it is determined that the lift of the recording sheet P occurs. In the present embodiment, since a displacement of the projection 22c is detected by the optical sensor 23, the optical sensor 23 is unnecessary to detect a displacement of the contact plate 22a that is located below the shaft portions 22b, allowing greater flexibility (or degree of freedom) for location of the optical sensor 23. In other words, because the contact plate 22a has the plate structure extending in the lengthwise direction thereof as shown in FIG. 3A, positions in the printer 1 for placing a sensor for detecting the displacement of the contact plate 22a are restricted. However, because the projection 22c consists of a portion projecting upward from the contact plate 22a, the projection 22c can be made relatively small and the optical sensor 23 can be easily disposed. Further, though the projection 22c projects upward from the center of the contact plate 22a in the lengthwise direction thereof in FIG. 3A, instead of this, the projection 22c may project upward from a right end portion or a left end portion of the contact plate 22a with respect to the center thereof.

Hereinafter, the lift of the recording sheet P that is detected by the pendular member 22 and the optical sensor 23 will be described with reference to FIGS. 4A and 4B. As shown in FIG. 4A, the pendular member 22 usually (or normally) stands still or is positioned at the static position in a state of hanging down (or straight) in the vertical direction. In a case where the recording sheet P is not lifted from the outer circumferential surface 8a of the feed belt 8, the recording sheet P passes through a space between the lower end of the contact plate 22a and the outer circumferential surface 8a of the feed belt 8 without contacting the contact plate 22a and then passes below the four printing heads 2 in order. Then, the recording sheet P is, after an image being recorded thereon, discharged to the sheet-discharge portion 31.

On the other hand, as shown in FIG. 4B, in a case where the recording sheet P is fed in a state in which an edge (the leading edge) thereof is lifted from the outer circumferential surface 8a of the feed belt 8, the leading edge of the recording sheet P contacts the contact plate 22a. When the recording sheet P contacts the contact plate 22a, the pendular member 22 pivots in the feeding direction and the projection 22c is displaced from a static (resting) position, so that the light emitted from the light-emitting portion is received by the light-receiving portion. When the light-receiving portion receives the light, the ON signal is outputted from the optical sensor 23 to the CPU 88. Accordingly, in the CPU 88, it is determined that the lift of the recording sheet P occurs, so that a feeding operation of the recording sheet P by the feeding unit 21 and a printing operation of the recording sheet P by the printing heads 2 are stopped or suspended before the recording sheet P in the state of lift is fed to the printing heads 2.

Therefore, because the pendular member 22 is located on the upstream side of the ink ejection surfaces 2a of the printing heads 2 in the feeding direction, in the case where the recording sheet P in the state of lift is fed, the lift of the recording sheet P can be certainly detected and the feeding operation of the recording sheet P can be stopped before the image is formed thereon.

In the present embodiment, the lower end of the contact plate 22a of the pendular member 22 is disposed to be closer to the outer circumferential surface 8a of the feed belt 8 in the vertical direction than the ink ejection surfaces 2a of the printing heads 2. In other words, a distance (an interval) between the lower end of the contact plate 22a and the outer circumferential surface 8a of the feed belt 8 is set to be smaller than the distance between the ink ejection surfaces 2a of the printing heads 2 and the outer circumferential surface 8a of the feed belt 8. Thus, in a case where the recording sheet P passes below the lower end of the contact plate 22a without contacting the same 22a, it is sure that the recording sheet P does not contact the ink ejection surfaces 2a of the printing heads 2. In other words, the recording sheet P in the state of lift from the outer circumferential surface 8a of the feed belt 8 can surely contact the contact plate 22a.

Further, in the present embodiment, in the case of contacting of the recording sheet P with the contact plate 22a, the feeding of the recording sheet P by the feeding unit 21 and the printing of the recording sheet P by the printing heads 2 are stopped. Accordingly, jamming, caused by feeding of the recording sheet P in the state of lift, is prevented from occurring, and the recording sheet P is prevented from being stained with ink because the recording sheet P contacts the ink ejection surfaces 2a of the printing heads 2.

Furthermore, in the printer 1 in the present embodiment, the printing heads 2 of line-type are adopted, and a dimension or a length of each printing head 2 in the main scanning direction is larger than that of a printing head of serial-type that is carried by a carriage. Thus, in the printing heads 2 in the present embodiment, a possibility that the recording sheet P contacts the printing heads 2 is higher than that in the printing head of serial-type. However, since the pendular member 22 has the width that is larger than the largest width of the recording sheet P among the recording sheets that are printable by the printer 1 (shown in FIG. 3B), in a case where any part of the recording sheet P in the main scanning direction is lifted, the lift of the recording sheet P can be surely detected. In other words, the pendular member 22 is more effective, especially in a case of using the printing heads 2 of line-type.

Hereinafter, an electric structure of the printer 1 will be described with reference to FIG. 5. As shown in FIG. 5, the printer 1 includes mainly the CPU (Central Processing Unit) 88, a ROM (Read Only Memory) 89, a RAM (Random Access Memory) 90, the operation keys 93, the state indication lamp 94, the printing heads 2, the optical sensor 23 and the feed motor 32.

The CPU 88, the ROM 89 and the RAM 90 are connected to each other via a busline 95. Further, the operation keys 93, the state indication lamp 94, the printing heads 2, the optical sensor 23, the feed motor 32 and the busline 95 are connected to each other via an I/O (Input/Output) port 96.

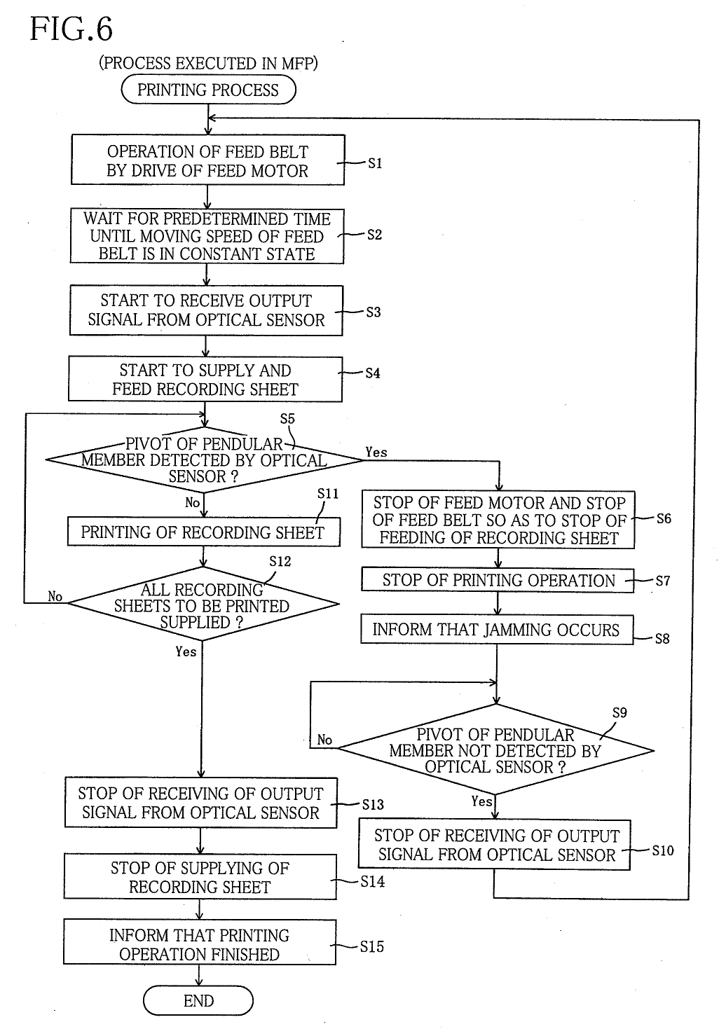

The CPU 88 controls, based on fixed values and/or programs that are stored in the ROM 89 or the RAM 90, various functions that the printer 1 has and controls respective portions that are connected to the I/O port 96. The ROM 89 is a non-rewritable memory in which control programs that are executed in the printer 1 and so forth are stored. A program for implementing or executing a printing process shown in a flow chart of FIG. 6 is stored in the ROM 89. The RAM 90 is a volatile rewritable memory for temporarily storing various data when implementing of various operations of the printer 1.

Hereinafter, the printing process that is implemented by the CPU 88 of the printer 1 will be described with reference to FIG. 6. The printing process includes especially a process for stopping or suspending the feeding and the printing of the recording sheet P when the printing is in progress in the case where the recording sheet P that is fed is lifted from the feed belt 8 (as shown in FIG. 4B).

In the printing process, first, in step S1, the feed motor 32 is operated such that the feed belt 8 is circulated. Then, in step S2, an elapse of a predetermined time period is waited until a moving speed of the feed belt 8 becomes in a constant (static) state, and after that, receiving of the output signal from the optical sensor 23 is started (step S3). These steps are implemented for prevention of an erroneous determination that the state of lift occurs in the recording sheet P, caused by the pivot of the pendular member 22 due to, e.g., occurrence of wind pressure or oscillation when the feed belt 8 is started to operate.

Next, in step S4, supplying of the recording sheet P by the sheet-supply roller 25 of the sheet-supply unit 1b starts and the feeding of the recording sheet P by the feed belt 8 starts, and then, it is determined whether the pivot of the pendular member 22 is detected by the optical sensor 23 (step S5). As mentioned before, in the case where the recording sheet P is fed without being lifted, the recording sheet P passes below the pendular member 22 without contacting the contact plate 22a, so that no signals are outputted from the optical sensor 23 to the CPU 88. On the other hand, in the case where the recording sheet P is fed in the state of lift, since a portion of the recording sheet P in the state of lift contacts the contact plate 22a, the pendular member 22 is pivoted and the projection 22c is displaced from the static position thereof, so that the light from the light-emitting portion of the optical sensor 23 is received by the light-receiving portion thereof. In this case, the ON signal is outputted from the optical sensor 23 to the CPU 88.

In step S5, in a case where the pivot of the pendular member 22 is detected by the optical sensor 23 (S5: YES), the recording sheet P is in the state of lift from the feed belt 8, so that a drive of the feed motor 32 is stopped and a circulation of the feed belt 8 is stopped so as to stop the feeding of the recording sheet P by the feed belt 8 (step S6), and an ejection of ink from the printing heads 2 is stopped so as to suspend an image printing operation (step S7).

In the present embodiment, in the case where the recording sheet P is lifted from the feed belt 8, the feeding of the recording sheet P is immediately stopped, so that the recording sheet P in the state of lift is stopped before being fed to the printing heads 2. Therefore, the jamming of the recording sheet P is prevented and also, the recording sheet P is certainly prevented from being stained with ink because the recording sheet P in the state of lift contacts the ink ejection surfaces 2a of the printing heads 2.

In step S8, it is informed or alarmed by the state indication lamp 94 that there is a high possibility that the jamming occurs because the recording sheet P is in the state of lift. Then, in step S9, it is determined whether the pivot of the pendular member 22 that has been detected by the optical sensor 23 is not (no longer) detected by the optical sensor 23 after the recording sheet P that is in contact with the pendular member 22 is removed.

In a case where the pivot of the pendular member 22 is still detected by the optical sensor 23 (S9: NO), an elapse of time is waited until the pivot of the pendular member 22 is not detected. On the other hand, in a case where the pivot of the pendular member 22 is not detected by the optical sensor 23 (S9: YES), in order to prepare for restarting of the supplying and feeding of the recording sheet P, receiving of the output signal from the optical sensor 23 is stopped in step S10, and then, an implementation of the printing process is returned to step S1.

In step S5, in a case where the pivot of the pendular member 22 is not detected by the optical sensor 23, that is, the recording sheet P does not contact the pendular member 22 (S5: NO), in step 11, the image is printed on the recording sheet P by ejecting ink from the printing heads 2.

Next, in step S12, it is determined whether all of the numbers of the recording sheets P to be printed are supplied. In a case where the recording sheets P to be supplied are still left (S12: NO), the implementation of the printing process returns to step S5 and respective steps S5 through S12 mentioned above are repeated. On the other hand, in a case where all of the numbers of the recording sheets P to be printed are supplied (S12: YES), receiving of the output signal from the optical sensor 23 is stopped in step S13, and supplying of the recording sheet P is stopped in step S14. Then, in step S15, it is informed by the state indication lamp 94 that the printing operation is finished, and one implementation of the printing process is ended.

In the above-described printing process shown in FIG. 6, in the case where the recording sheet P in the state of lift is fed, feeding of the recording sheet P and the printing operation by the printing heads 2 can be stopped before the recording sheet P in the state of lift is fed to the printing heads 2. Therefore, it can be surely prevented that the recording sheet P in the state of lift contacts the ink ejection surfaces 2a of the printing heads 2 and is stained with ink. It can be also prevented that the jamming occurs at the ink ejection surfaces 2a, caused by contacting of the recording sheet P in the state of lift with the ink ejection surfaces 2a. Further, the feed belt 8 that is disposed opposite to the printing heads 2 can be prevented from being stained with ink, caused by ejecting ink from the printing heads 2 under a circumstance with a high possibility that the jamming occurs. In the present embodiment, in step S5, in the case where the recording sheet P in the state of lift is fed, the feeding of the recording sheet P and the printing operation by the printing heads 2 are stopped (steps S6, S7). The present invention is not limited to this, and, in the case where the recording sheet P in the state of lift is fed, only either of the feeding operation of the recording sheet P and the printing operation by the printing heads 2 may be stopped.

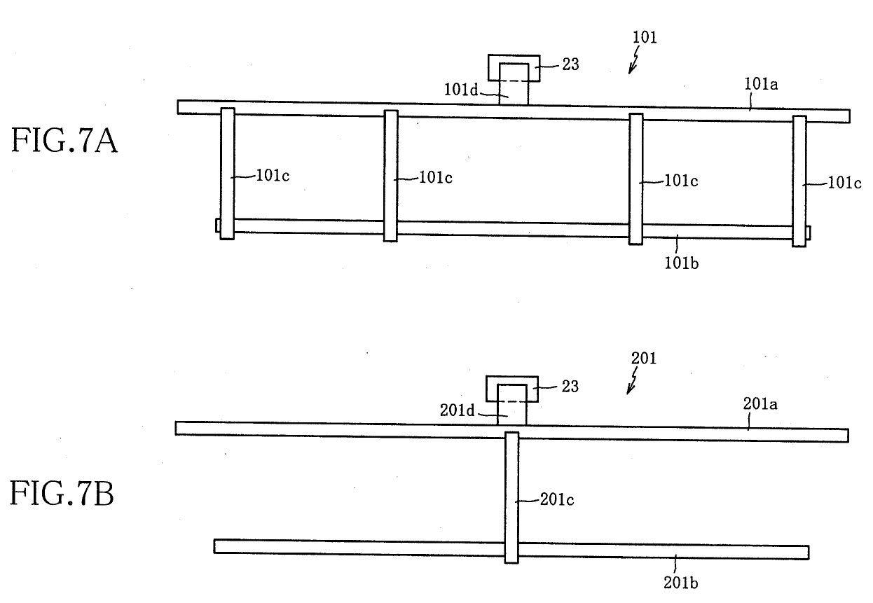

Hereinafter, modified embodiments of the pendular member 22 will be described with reference to FIGS. 7A and 7B. FIG. 7A shows a front view of a pendular member 101 and FIG. 7B shows a front view of a pendular member 201. On respective upper portions of the pendular members 101, 201, the optical sensors 23 are disposed so as to detect the pivot or the swing of the respective pendular members, 101, 201, similar to the pendular member 22. Because these optical sensors 23 are structured in the same way as the optical sensor 23 in the illustrated embodiment shown in FIGS. 1 through 6, a description thereof is omitted.

The pendular member 101 will be described with reference to FIG. 7A. As shown in FIG. 7A, the pendular member 101 consists of a plurality of rod-like members, whereas the pendular member 22 consists of a plate-like member in the illustrated embodiment.

The pendular member 101 consists of a shaft portion 101a that has a rod structure and extends in the direction perpendicular to the feeding direction of the recording sheet P or in the main scanning direction, a lower end portion 101b that has a rod structure and extends parallel to the shaft portion 101a with a predetermined distance (interval) therebetween, a plurality (four in the present modification) of connecting portions 101c that connect the shaft portion 101a with the lower end portion 101b, and a projection 101d that is disposed to stand upward from a center of the shaft portion 101a in a longitudinal direction thereof.

The shaft portion 101a is for supporting the pendular member 101 to be pivotable in the feeding direction and the direction opposite to the feeding direction and is rotatably supported by the inner portion of the casing 1a at opposite ends thereof. The lower end portion 101b is contactable with a lifted portion of the recording sheet P, and has a lateral width or a width in the main scanning direction that is larger than the largest width of the recording sheet P that is printable by the printer 1. The four connecting portions 101c connect the shaft portion 101a and the lower end portion 101b with each other and are arranged in the main scanning direction at predetermined intervals therebetween. The projection 101d consists of a light-intercepting or light-shielding member and is disposed to be surrounded by the optical sensor 23 or is disposed between the light-emitting portion and the light-receiving portion of the optical sensor 23.

In the present embodiment, since the shaft portion 101a, the lower end portion 101b, the connecting portions 101c and the projection 101d are formed of rod-shaped members, the pendular member 101 can save or reduce weight, compared to the pendular member 22 formed of the plate member. Therefore, when the recording sheet P contacts the pendular member 101, a range of pivot of the pendular member 101 can be increased, so that an accuracy of detection of a displacement of the projection 101d by the optical sensor 23 can be improved. Moreover, compared to the pendular member 22, the pendular member 101 can be insusceptible to wind blowing around the pendular member 101. Thus, an erroneous detection affected by wind can be restrained, the accuracy of detection of the displacement of the projection 101d by the optical sensor 23 can be further improved.

The pendular member 201 will be described with reference to FIG. 7B. The pendular member 201 has one connecting portion 201c, instead of the four connecting portions 101c of the pendular member 101 shown in FIG. 7A, and also has a shaft portion 201a, a lower end portion 201b and a projection 201d, similar to the pendular member 101.

Because the pendular member 201 has the connecting portion 201c that is smaller in number than the connecting portions 101c of the pendular member 101, the pendular member 201 can save or reduce further weight, compared to the pendular member 101. Therefore, when the recording sheet P contacts the pendular member 201, a range of pivot of the pendular member 201 can be more increased, so that the accuracy of detection of the displacement of the projection 201d by the optical sensor 23 can be further improved than the pendular member 101. Moreover, compared to the pendular member 101, the pendular member 201 can be less insusceptible to wind around the pendular member 201. Thus, the accuracy of detection of the displacement of the projection 101d by the optical sensor 23 can be further improved.

The present invention is not limited to the illustrated embodiments. It is to be understood that the present invention may be embodied with various changes and modifications that may occur to a person skilled in the art, without departing from the spirit and scope of the invention defined in the appended claims.

For example, in the printing process (shown in FIG. 6) in the illustrated embodiment shown in FIGS. 1 through 6, in the case where the pivot of the pendular member 22 is detected by the optical sensor 23 (S5: YES), it is determined that the recording sheet P is in the state of lift from the feed belt 8, so that the feed motor 32 is stopped and the circulation of the feed belt 8 is stopped so that the feeding of the recording sheet P by the feed belt 8 is stopped (S6). Alternatively, the feed motor 32 may be rotated in a reversed direction that is opposite to a normal direction in which the feed motor 32 is rotated during the feeding of the recording sheet P, so that the fed recording sheet P is returned to the sheet-supply unit 1b. In this embodiment, since the user can remove the recording sheet P that is returned to the sheet-supply unit 1b, leading to saving of many steps or a reduction of time and effort, compared to removing of the recording sheet P by opening the inner portion of the printer 1 so as to be accessible to the user.

Further, in the printing process (shown in FIG. 6) in the illustrated embodiment, in the case where the pivot of the pendular member 22 is detected by the optical sensor 23 (S5: YES), it is determined that the recording sheet P is in the state of lift from the feed belt 8, so that the feed motor 32 is stopped and the circulation of the feed belt 8 is stopped so that the feeding of the recording sheet P by the feed belt 8 is stopped (S6). Alternatively, the feed motor 32 may be rotated in the reversed direction, so that the recording sheet P in the state of lift is returned to the nip roller 4 so as to be pressed again on the outer circumferential surface 8a of the feed belt 8 by the nip roller 4. Then, the feed motor 32 may be rotated in the normal direction again so as to feed the recording sheet P again. In this embodiment, in the case where the recording sheet P passes below the pendular member 22 without contacting the same 22, the user does not need to remove the recording sheet P, leading to the reduction of time and effort.

In the illustrated embodiments, in the state in which the recording sheet P is lifted from the outer circumferential surface 8a of the feed belt 8, the recording sheet P contacts a contact portion including the contact plate 22a and the lower end portions 101b, 201b and the contact portion including the contact plate 22a and so on is pivoted. However, the present invention is not limited to this, for example, a detecting portion including a contact sensor for detecting a contact of the recording sheet P with the contact portion may be provided in the contact portion, and the detecting portion may detect that the recording sheet P is in the state of lift from the outer circumferential surface 8a of the feed belt 8 without the pivot of the contact portion. In this embodiment, because a space for the pivot of the contact portion is not required, the pendular members 22, 101, 201 can be located closer to the printing heads 2, so that installation space for the pendular members 22, 101, 201 can be saved.

Furthermore, in the illustrated embodiment, the optical sensor 23 is used as a sensor for detecting the displacement of the projection 2c of the pendular member 22. Alternatively, the displacement of the projection 2c may be detected by using a rotary encoder or a potentiometer and measuring an angle of the pivot of the pendular member 22. An ultrasonic sensor may also detect the displacement of the projection 2c by the pivot of the pendular member 22. Further, the following structure may be adopted. A magnetic body is attached to a part of the pendular member 22, and a magnetic sensor is disposed for detecting magnetism of the magnetic body. The displacement of the projection 2c is detected by measuring a change of the magnetism.

What is claimed is:

1. An image forming apparatus comprising:
an image forming portion which includes a nozzle surface having at least one nozzle and which is configured to form an image on a recording medium by ejecting ink toward the recording medium through the at least one nozzle;
a feeding portion which includes a feeding surface on which the recording medium is placed and which is configured to feed the recording medium toward the image forming portion in a feeding direction; and
a detecting portion which is configured to detect a state of lift of the recording medium relative to the feeding surface; and
wherein the detecting portion includes a contact portion which is contactable with at least a part of a portion of the recording medium that is in the state of lift and a sensing portion which senses that the recording medium and the contact portion contact with each other.

2. The image forming apparatus according to claim 1, wherein the contact portion is displaceable from a position thereof before contacting with the recording medium to another by contacting with the recording medium, and
wherein the sensing portion senses that the recording medium and the contact portion contact with each other based on a displacement of the contact portion.

3. The image forming apparatus according to claim 1, wherein the contact portion is located at a position that is spaced from the feeding surface at a predetermined distance.

4. The image forming apparatus according to claim 1, wherein the contact portion is located on an upstream side of the image forming portion in the feeding direction of the recording medium.

5. The image forming apparatus according to claim 1, wherein the contact portion is a pendular member which extends in a direction perpendicular to the feeding direction and parallel to the feeding surface, and
wherein the sensing portion senses a swing of the pendular member that occurs when the recording medium and the contact portion contact with each other.

6. The image forming apparatus according to claim 1, wherein a width of the contact portion measured in a direction perpendicular to the feeding direction and parallel to the feeding surface is made larger than a width of the recording medium that is measured in a direction perpendicular to the feeding direction and parallel to the feeding surface and that is the largest width among recording media on which the image forming portion can form an image.

7. The image forming apparatus according to claim 1, wherein the detecting portion includes at least one shaft portion for the contact portion to be pivotable about and an operating portion which is located at a position that is opposite to the contact portion with respect to the shaft portion and which is operable to be synchronized with a pivot of the contact portion, and
wherein the sensing portion senses that the recording medium and the contact portion contact with each other based on a displacement of the operating portion.

8. The image forming apparatus according to claim 1, wherein a distance between the contact portion and the feeding surface is equal to or smaller than a distance between the nozzle surface and the feeding portion.

9. The image forming apparatus according to claim 1, wherein the contact portion has a plate shape whose direction of thickness is the feeding direction and whose longitudinal direction is a direction perpendicular to the feeding direction.

10. The image forming apparatus according to claim 5, wherein the pendular member includes (1) a lower end portion which extends in the direction perpendicular to the feeding direction and parallel to the feeding surface, (2) a shaft portion which is for the pendular member to be pivotable about and which is spaced from the lower end portion and extends parallel to the lower end portion, and (3) at least one connecting portion by which the shaft portion and the lower end portion are connected with each other.

11. The image forming apparatus according to claim 9, wherein each of the lower end portion, the shaft portion and the connecting portion has a rod shape.

12. The image forming apparatus according to claim 1, further comprising a suspending portion which, in a case where the sensing portion senses a contact of the recording medium and the contact portion, suspends at least one of a feeding operation of the recording medium by the feeding portion and an ejection of ink by the image forming portion.

13. The image forming apparatus according to claim 1, wherein the feeding portion includes a pair of rollers which are spaced from each other at a predetermined distance in the feeding direction of the recording medium and an endless belt which is wound on the pair of rollers, and
wherein the image forming portion is located between the pair of rollers in the feeding direction.
